(19) United States
(12) Patent Application Publication
(10) Pub. No.: US 2017/0076238 A1
(43) Pub. Date: Mar. 16, 2017

(54) PROMPTING CONTEXT-SPECIFIC FEEDBACK REGARDING A GOAL

(71) Applicant: International Business Machines Corporation, Armonk, NY (US)

(72) Inventors: Paul R. Bastide, Boxford, MA (US); Matthew E. Broomhall, Goffstown, NH (US); Sean Callanan, Churchtown (IE); Sandra L. Kogan, Newton, MA (US)

(21) Appl. No.: 14/854,867

(22) Filed: Sep. 15, 2015

(51) Int. Cl. G06Q 10/06

(52) U.S. Cl. CPC G06Q 10/06398

(57) ABSTRACT

First information indicating at least a first goal for a first user can be received and stored to a storage device. Electronic communications communicated in at least one social system can be monitored. The electronic communications can be processed to identify at least one of the electronic communications comprising second information related to the first goal. A health of the first goal can be determined by processing the second information related to the first goal contained in the identified at least one of the electronic communications. Responsive to determining the health of the first goal, a first electronic message prompting a second user to provide to the first user feedback regarding the first goal can be automatically generating based on the health of the first goal. The first electronic message can be communicated for presentation to at least the second user.

### BACKGROUND

The present invention relates to performance management systems.

Performance management systems sometimes are used to facilitate performance management. Performance management is a systematic process by which an organization involves its employees, as individuals and members of a group, in improving organizational effectiveness. Performance management includes the setting of goals for employees and periodically rating employee performance.

### SUMMARY

A method includes receiving first information indicating at least a first goal for a first user and storing the first information to a storage device. The method also includes monitoring electronic communications communicated in at least one social system and processing, using a processor, the electronic communications to identify at least one of the electronic communications comprising second information related to the first goal. The method also includes determining a health of the first goal by processing the second information related to the first goal contained in the identified at least one of the electronic communications. The method also includes, responsive to determining the health of the first goal, automatically generating, based on the health of the first goal, a first electronic message prompting a second user to provide to the first user feedback regarding the first goal and communicating the first electronic message for presentation to at least the second user.

A system includes a processor programmed to initiate executable operations. The executable operations include receiving first information indicating at least a first goal for a first user and storing the first information to a storage device. The executable operations also include monitoring electronic communications communicated in at least one social system and processing the electronic communications to identify at least one of the electronic communications comprising second information related to the first goal. The executable operations also include determining a health of the first goal by processing the second information related to the first goal contained in the identified at least one of the electronic communications. The executable operations also include, responsive to determining the health of the first goal, automatically generating, based on the health of the first goal, a first electronic message prompting a second user to provide to the first user feedback regarding the first goal and communicating the first electronic message for presentation to at least the second user.

A computer program includes a computer readable storage medium having program code stored thereon. The program code is executable by a processor to perform a method. The method includes receiving, by the processor, first information indicating at least a first goal for a first user and storing, by the processor, the first information to a storage device. The method also includes monitoring, by the processor, electronic communications communicated in at least one social system and processing, by the processor, the electronic communications to identify at least one of the electronic communications comprising second information related to the first goal. The method also includes determining, by the processor, a health of the first goal by processing the second information related to the first goal contained in the identified at least one of the electronic communications. The method also includes, responsive to determining the health of the first goal, automatically generating, by the processor, based on the health of the first goal, a first electronic message prompting a second user to provide to the first user feedback regarding the first goal and communicating, by the processor, the first electronic message for presentation to at least the second user.

### BRIEF DESCRIPTION OF THE DRAWINGS

FIG. 1 is a block diagram illustrating an example of a computing environment.

FIGS. 2a and 2b are a flow chart illustrating an example of a method of prompting a user to provide feedback regarding a goal to another user.

FIG. 3 is a block diagram illustrating example architecture for a performance management system.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to performance management systems and, more particularly, to a performance management system that prompts managers to provide feedback to employees regarding their progress at achieving goals. Rather than feedback being provided at some defined interval (e.g., annually), the arrangements described herein monitor the health of goals by monitoring electronic communications in one or more social system(s), and prompt managers to provide context-specific feedback based on the health of the goals as indicated by the monitored electronic communications. The electronic communications need not be specifically communicated to the managers. For example, natural language processing (NLP) and semantic analysis can be performed on electronic communications, which are exchanged in the social system(s) to identify those electronic communications which include information pertaining to goals, and such information can be processed to automatically determine the health of the goals.

Several definitions that apply throughout this document now will be presented.

As defined herein, the term “health” means a state of activity pertaining to a goal. Examples of a state of activity pertaining to a goal include, but are not limited to, inactive, active, failure and success. Thus, the health of a goal can be inactive, active, failure or success.

As defined herein, the term “social system” means a system including one or more processors that supports communication between members of a social network. Examples of a social system include an e-mail system, an instant messaging system, a text messaging system, a collaboration site, a blog, an Internet forum, and a social networking site. As defined herein, a “performance management system” is not a “social system.”

As defined herein, the term “feedback” means evaluative or corrective information pertaining to a task, milestone or goal.

As defined herein, the term “feedback message” means an electronic message containing feedback.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

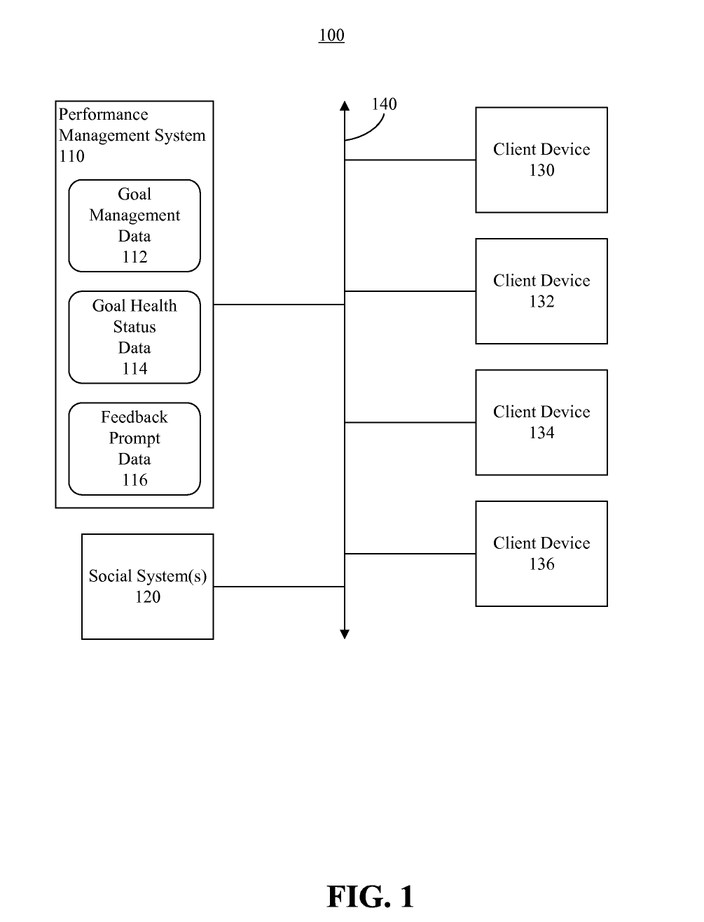

FIG. 1 is a block diagram illustrating an example of a computing environment 100. The computing environment 100 can include a performance management system 110, one or more social systems 120 and a plurality of client devices 130, 132, 134, 138 which are communicatively linked via at least one network 140. The social system(s) 120 can be public or private social systems. Each client device 130-138 can be implemented as a processing system, including at least one processor and memory, configured to communicate with the performance management system 110 and the social system(s) 120 via the network 140. Examples of client devices 130-138 include, but are not limited to, workstations, desktop computers, mobile computers, laptop computers, tablet computers, netbook computers, smart phones, personal digital assistants, set top boxes, and the like.

The network 140 is the medium used to provide communications links between various client devices 130-136, the performance management system 110 and the social system(s) 120 connected together within the computing environment 100. The network 140 may include connections, such as wire, wireless communication links, or fiber optic cables. The network 140 can be implemented as, or include, any of a variety of different communication technologies such as a WAN, a LAN, a wireless network, a mobile network, a Virtual Private Network (VPN), the Internet, the Public Switched Telephone Network (PSTN), or the like.

The performance management system 110 can include at least one processor and memory configured to process various data related to goals. Such data can include, for example, goal management data 112, goal health status data 114 and feedback prompt data 116, which may be stored by the performance management system 110 to a computer-readable storage medium. For example, the goal management data 112, goal health status data 114 and feedback prompt data 116 can be stored to one or more data tables, data files, or the like. Moreover, the goal management data 112, goal health status data 114 and feedback prompt data 116 may be stored locally on the performance management system 110, or stored to a remote system or device and accessed by the performance management system 110 when needed for processing.

Via the client devices 130-134, users can interact with the performance management system 110 to establish goals. For example, a user (e.g., a manager or supervisor) can sponsor a goal for another user (e.g., an employee). To sponsor the goal, the manager can interact with a user interface of the performance management system 110, via a respective client device 130-136, to define the goal within the performance management system 110. Optionally, the manager can assign a ranking to the goal representing the importance of the goal. The goal and ranking can be stored by the performance management system 110 as goal management data 112.

Via the performance management system 110, the employee can accept or decline the goal. To accept the goal, for example, the employee can interact with the user interface of the performance management system 110, via a respective client device 130-136, to subscribe to the goal. Responsive to the employee accepting the goal, the performance management system 110 can communicate an electronic message to the manager indicating that the employee has accepted/subscribed to the goal. For instance the performance management system 110 can communicate the electronic message via the social system 120 or present the electronic message in the user interface of the performance management system 110. If the employee declines the goal, the performance management system 110 can communicate a corresponding electronic message to the manager.

In the case that the employee accepts the goal, the employee or manager can assign to the goal, via the user interface of the performance management system 110, various tasks and/or milestones and due dates for accomplishing those tasks/milestones. Optionally, the employee or manager can assign to each task and/or milestone a ranking indicating the importance of the task and/or milestone. The employee or manager also can assign to the goal a goal completion date. Any such information provided for the goal can be added to the goal management data 112.

In addition, the employee or the manager can, via the user interface of the performance management system 110, assign the goal to an update category. For goals that are assigned to the update category, the performance management system 110 can be configured to monitor electronic communications exchanged/posted in the social system(s) 120 which include information pertaining to those goals. By way of example, the performance management system 110 can subscribe to e-mails sent to or received by the employee, the manager and/or members of user group (e.g., a group of users in a particular department, division and/or a group of users cooperatively working on a particular project). The performance management system 110 also can subscribe to text messages and/or instant messages sent to or received by the employee, manager and/or members of the user group. Further, the performance management system 110 also can subscribe to posts by the employee, manager and/or members of the user group on collaboration sites, bogs, forums and/or social networking sites. Accordingly, the present arrangements consider not only communications exchanged between a manager and an employee, but also social interactions among and between colleagues, for example within a collaboration space.

Subscribing to the various social systems 120, the performance management system 110 can receive the e-mails, texts and posts, and process such, in real time, to identify information related to the goal set for the employee. The related information can include information directly related to the goal and/or information related to tasks and/or milestones associated with the goal. To identify the information, the performance management system 110 can implement NLP and semantic analysis on information contained in the e-mails, texts and posts. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input.

The performance management system 110 can process the identified information to automatically determine the health of the goal and generate the goal health status data 114, which the performance management system 110 can store to a computer-readable storage medium. For example, the performance management system 110 can determine whether the identified information indicates whether the employee has accomplished the goal or accomplished any tasks/milestones related to the goal, and when such were accomplished. The performance management system 110 also can process the identified information to determine whether the employee failed to accomplish tasks/milestones and/or the goal, or failed to do so by their specified due dates. By way of further example, the performance management system 110 can process the identified information to determine whether there has been activity toward achieving the goal or whether there has been a lack of, or no, activity toward achieving the goal. Data generated based on such analysis can be stored as the goal health status data 114. At this point it should be noted that when determining the health of the goal, the performance management system 110 can identify a time window in which the tasks/milestones/goal are indicated as to be accomplished. The time window may be based on all time, since the employee became employed, or since the manager last engaged or had an update on the goal from the user.

Responsive to the performance management system 110 determining the health of the goal based on the goal health status data 114, the performance management system 110 can, in real time, prompt the manager to provide to the employee context-specific feedback regarding the goal. In illustration, the performance management system 110 can automatically generate an electronic message and communicate the electronic message to the manager. In one arrangement, the electronic message can be an e-mail, a text message, an instant message or a post on a collaboration site, blog, forum or social networking site. In another arrangement, the electronic message can be a message presented to the manager in a user interface provided by the performance management system 110. For example, the message can be presented to the manager responsive to the manager logging into the performance management system 110 or the manager viewing a user interface containing updates related to the goal. The electronic message can indicate the employee, the goal, desired tasks/milestones, due dates, and information indicating whether the tasks/milestones/goal was/were achieved, whether there has been activity regarding the tasks/milestones/goal, whether there has not been activity regarding the tasks/milestones/goal, whether the user failed to accomplish the tasks/milestones/goal, etc. Responsive to receiving the electronic message, the manager can craft an electronic message to be sent to the employee and, optionally, other users, or to be posted on a network or forum.

In one arrangement, the electronic message can present to the manager one or more proposed context-specific feedback messages. Such messages can be generated based the feedback prompt data 116, but optionally also can include certain goal management data 112 and goal health status data 114. For example, if the employee has achieved the goal, the electronic message can present a menu of proposed feedback messages from which the manager can select a proposed feedback. Examples of proposed feedback messages include, but are not limited to, “Great Job,” “Continue the Great Work,” a colloquialism such as “uh huh, dude?,” etc. In further examples, the proposed feedback messages can include information related to tasks, milestones and/or the goal achieved. If the determined health of the goal indicates that the employee has not met a task, milestone and/or goal in a timely manner, the proposed feedback messages can include words of encouragement to the employee, advice, warnings, or the like. For example, if the determined health of the goal indicates no activity on the part of the employee toward achieving the goal, a proposed feedback message can indicate such.

Further, the performance management system can configure proposed feedback messages for the manner in which the feedback messages will be communicated to the employee. For example, proposed feedback messages to be sent directly to the employee can be specific, including actions/milestones/goals met or not met, and specific advice to the employee. Proposed feedback messages to be also sent to other users or posted on a collaboration site, blog, forum or social networking site can be more generic. For example, such messages can be limited to words of congratulations or words of encouragement. In this regard, the sentiment of the proposed feedback messages can be automatically selected based on the intended of the feedback messages.

Moreover, the manner in which the feedback messages are communicated can be based on the nature of the feedback messages. For example, if the health of a goal indicates that activity toward obtaining the goal is inactive or the employee has failed at meeting the goal, a corresponding feedback message can be addressed to, and sent to, only the employee, or sent only to the employee and other managers/stakeholders who are affected by the outcome of whether the employee meets the goal. On the other hand, if the health of a goal indicates that the employee has met the goal, the feedback message can be posted to a collaboration site, blog, forum or social networking site for the employee and others to see, or can be sent as a group message to multiple users who belong to a team that includes the employee.

The proposed feedback messages also can be generated by the performance management system 110 to correspond to the importance of the task, milestone or goal. For example, if the health status of the goal indicates that a minor task or milestone is achieved, a proposed feedback message can be “+1.” If, however, the health status of the goal indicates that a major goal has been achieved, a proposed feedback message can be “Great jog at achieving [stated goal]!!! This is a major accomplishment and the entire team greatly appreciates your effort!”

Further, the proposed feedback messages can be customized for the employee based on information of the employee obtained by the performance management system 110. For example, the performance management system 110 can monitor a pattern of success of the employee achieving tasks, milestones and/or goals, and customize the proposed feedback messages based on such pattern of success. In illustration, if the goal management data 112 and goal health status data 114 indicates that the employee is continually achieving tasks, milestones and/or goals, a proposed feedback message can indicate such. An example of a proposed feedback message can be “Congratulations accomplishing another goal. Keep up the good work!” In another example, if the goal management data 112 and goal health status data 114 indicates that the employee is not regularly achieving tasks, milestones and/or goals, a proposed feedback message can be “You may be having difficulty achieving [stated task/milestone/goal], but you can do it. Stay focused.” In this regard, the performance management system 110 can process goal management data 112 and goal health status data 114 corresponding to a plurality of goals set for the employee to evaluate the employee's success and failure rates at achieving tasks, milestones and/or goals in a timely manner, evaluate the number of active tasks, milestones and/or goals assigned to the employee, etc. The performance management system 110 can process such evaluations to derive the proposed feedback messages in order to provide the proper level of reinforcement for successful behavior.

The manager can select at least one of the proposed feedback messages from the menu to send to the employee. In one arrangement, the proposed feedback messages can be configured to be editable. Thus, the manager can edit the selected proposed feedback message(s) my changing the text, adding additional text, adding icons, emoticons, or the like, adding an image, adding a multimedia file, etc.

Responsive to the manager selecting a proposed feedback message from the menu and, optionally, editing the selected proposed feedback message, the manager can choose a suitable button, icon or menu item to initiate communication of the selected proposed feedback message. In response, the performance management system 110 can interface with the social system 120 to create an electronic message and/or post including the selected proposed feedback message. In illustration, in the case that an electronic message is created, the electronic message can be automatically addressed by the performance management to be sent to the employee and, optionally, one or more other users (e.g., a group of users in a particular department, division and/or a group of users cooperatively working on a particular project), and the performance management system 110 can initiate the social system 120 to send the electronic message to the users to whom the electronic message is addressed. In the case that a post is created, the performance management system 110 can initiate the social system 120 to enter the post into a corresponding collaboration site, blog, forum or social networking site.

In one aspect of the present arrangements, the performance management system 110 can prompt the manager not only to provide a feedback message to the employee, but also to mention the employee in an electronic message sent to a group of users or posted to a collaboration site, blog, forum or social networking site. For example, the performance management system 110 can prompt the manager to mention the employees accomplishments in an e-mail or text message sent to a team, or in a collaboration site, blog, forum or social networking site used by team members. The manager also can be prompted to encourage others to send messages of encouragement, congratulations, etc. to the employee or post such messages on a collaboration site, blog, forum or social networking site.

The performance management system 110 also can prompt managers to be proactive in communicating with employees regarding in-process tasks, milestones and/or goals. For example, prior to a due date of a task, milestone or goal, the performance management system 110 can communicate to the manager an electronic message prompting the manager to provide to the employee a feedback message including a reminder of the task, milestone or goal and the corresponding due date. In illustration, the manager can be prompted to provide the feedback reminder one month before the due date, one week before the due date, three days before the due date, two days before the due date, one day before the due date, or the like. Again, proposed feedback messages can be presented in a menu from which the manager can choose the feedback message, and the proposed feedback messages can include a suggested action, words of encouragement, words of concern, words of warning, etc.

In some circumstances a manager may manage many employees who each have their own goals, tasks and milestones. There may be tasks and milestones achieved by numerous employees on a regular basis. Rather than requiring the manager to select individual feedback messages for each employee, the performance management system 110 can present to the manager an option to easily provide feedback messages to multiple employees in a single user operation. For example, the performance management system 110 can present to the manager a menu item to send feedback messages for a plurality of employees who have met their tasks, milestones, goals. In illustration, the manager can be presented a menu of items selectable by the manager to generate a plurality of feedback messages indicating “+1” or “Great Job” for each employee who has met a task or milestone. Responsive to the manager selecting such menu item, corresponding feedback messages can sent to the respective employees or posted to a collaboration site, blog, forum or social networking site, for example as previously described. Nonetheless, the manager can be prompted to select or generate more complex feedback messages for those employees accomplishing major goals and/or milestones. In this regard, the performance management system 110 can determine whether a feedback response for a task, milestone or goal should be more complex based on the ranking assigned to the task, milestone or goal.

In one aspect of the present arrangements, the manager can configure the performance management system 110 with a default message, and that default message can be sent to each of the employees determined by the performance management system 110 to have achieved a task, milestone and/or goal. For example, each time the performance management system 110 determines that a task, milestone and/or goal has been achieved by an employee, the performance management system 110 can automatically send to that employee the default message or post the default message in a collaboration site, blog, forum or social networking site with an identifier in the message indicating the employee.

In some cases, a manager may not generate feedback message or select a proposed feedback message when receiving the electronic message prompting the manager to do so. The performance management system 110 can monitor the manager's menu selections and electronic communications sent via the social system(s) 120 to determine whether the manager has initiated sending of the feedback messages for which the manager is prompted. The performance management system 110 also can periodically re-prompt the manager to initiate the feedback messages, either by creating the feedback messages or selecting the feedback messages from a menu. At some point in time the feedback messages may no longer be effective at motivating the employees, for example after a period of time after a task, milestone or goal has been met. Thus, the performance management system 110 can cease prompting the manager to provide feedback on certain tasks, milestones or goals after a certain time period after the tasks, milestones or goals has elapsed.

In another aspect of the present arrangements, the performance management system 110 can, based on communications exchanged via the social system(s) 120, automatically determine additional tasks, milestones and/or goals for users. For example, if a manager communicates a feedback message to an employee or posts a feedback message in a collaboration site, blog, forum or social networking site, the performance management system 110 can implement NLP and semantic analysis on information contained in the feedback message to identify information suggesting additional tasks, milestones and/or goals for the employee. In illustration, if the feedback message pertains to a goal of synchronizing an e-mail system with a new platform and includes the following text “you should resolve the e-mail migration issue before trying to synchronize the e-mail system with the new platform,” the performance management system 110 can, based on NLP and semantic analysis, infer a new goal of resolving the e-mail migration issue. In this regard, the performance management system 110 can include data (e.g., data tables and/or a data base) used during NLP and semantic analysis to analyze information contained in the feedback message(s) to facilitate identification of new tasks, milestones and/or goals.

Responsive to automatically determining the new goal, the performance management system 110 can automatically generate a corresponding electronic message indicating the new goal and communicate the electronic message to the manager, thereby prompting the manager to consider sponsoring the new goal. If the manager so chooses, the manager can define the goal and assign the goal to the employee. The employee may subscribe to the goal, for example as previously described.

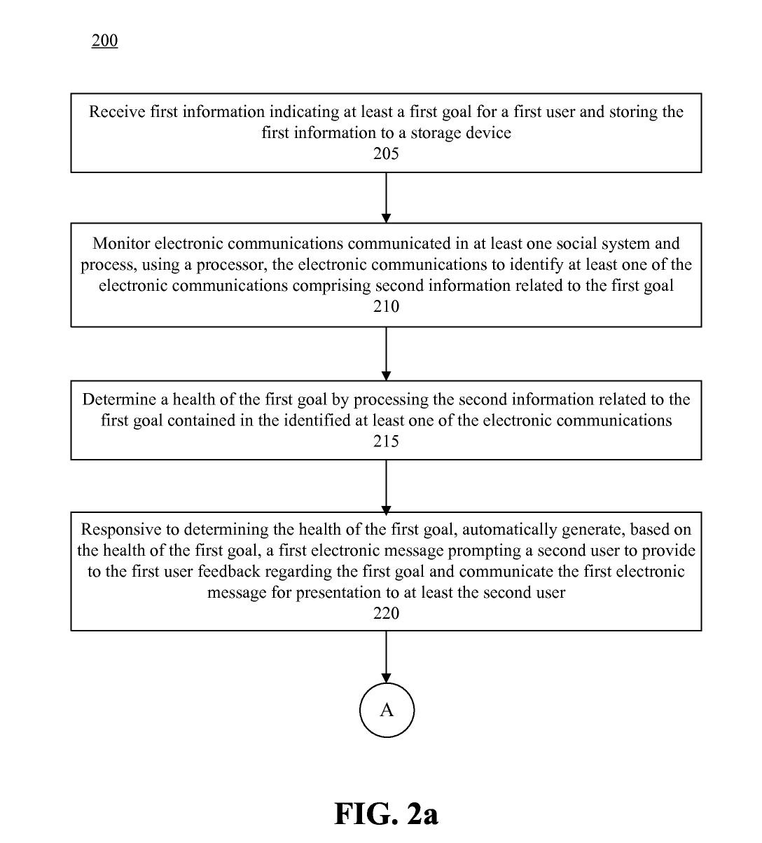

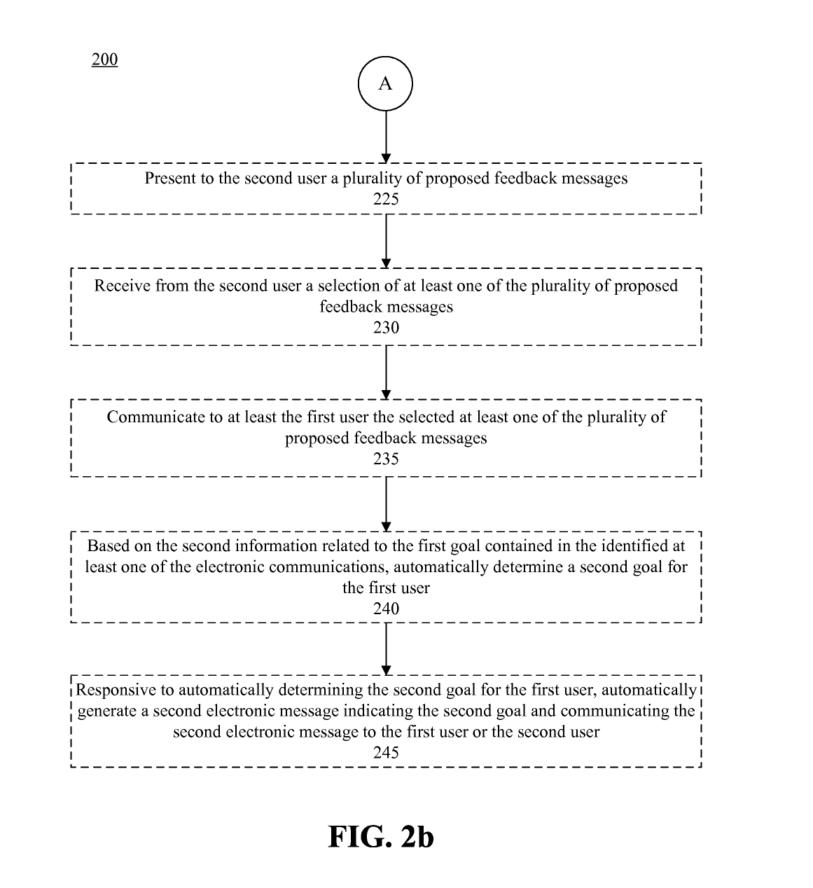

FIGS. 2a and 2b are a flow chart illustrating an example of a method 200 of prompting a user to provide feedback regarding a goal to another user. At step 205, first information indicating at least a first goal for a first user can be received and the first information can be stored to a storage device. The first information can be received from a user, for example a manager.

At step 210, electronic communications communicated in at least one social system can be monitored. The electronic communications can be processed, using a processor, to identify at least one of the electronic communications comprising second information related to the first goal. At step 215, a health of the first goal can be determined by processing the second information related to the first goal contained in the identified at least one of the electronic communications. At step 220, responsive to determining the health of the first goal, a first electronic message prompting a second user to provide to the first user feedback regarding the first goal can be automatically generated based on the health of the first goal. The first electronic message can be communicated for presentation to at least the second user. For example, the first electronic message can be sent as an e-mail, a text message, or an instant message, or sent as a post in a collaboration site, blog, forum or social networking site.

Optionally, at step 225, a plurality of proposed feedback messages can be presented to the second user. At step 230, a selection of at least one of the plurality of proposed feedback messages can be received from the second user. At step 235, the selected at least one of the plurality of proposed feedback messages can be communicated to at least the first user.

Optionally, at step 240, a second goal for the first user can be automatically determined based on the second information related to the first goal contained in the identified at least one of the electronic communications. At step 245, responsive to automatically determining the second goal for the first user, a second electronic message indicating the second goal can be automatically generated. The second electronic message can be communicated to the first user or the second user.

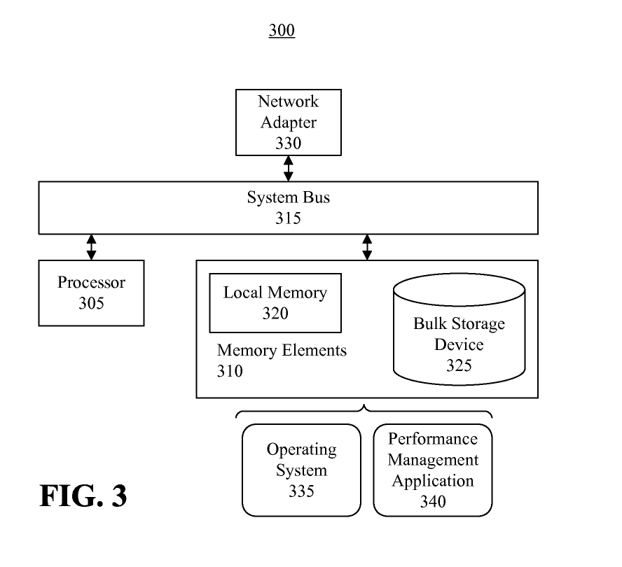

FIG. 3 is a block diagram illustrating example architecture for the performance management system 110. The performance management system 110 can include at least one processor 305 (e.g., a central processing unit) coupled to memory elements 310 through a system bus 315 or other suitable circuitry. As such, the performance management system 110 can store program code within the memory elements 310. The processor 305 can execute the program code accessed from the memory elements 310 via the system bus 315. It should be appreciated that the performance management system 110 can be implemented in the form of any system including a processor and memory that is capable of performing the functions and/or operations described within this specification. For example, the performance management system 110 can be implemented as a server or other computer.

The memory elements 310 can include one or more physical memory devices such as, for example, local memory 320 and one or more bulk storage devices 325. Local memory 320 refers to random access memory (RAM) or other non-persistent memory device(s) generally used during actual execution of the program code. The bulk storage device(s) 325 can be implemented as a hard disk drive (HDD), solid state drive (SSD), or other persistent data storage device. The performance management system 110 also can include one or more cache memories (not shown) that provide temporary storage of at least some program code in order to reduce the number of times program code must be retrieved from the bulk storage device 325 during execution.

Input/output (I/O) devices such as one or more network adapters 330 can be coupled to the performance management system 110. The I/O devices can be coupled to the performance management system 110 either directly or through intervening I/O controllers. The network adapter(s) 330 can enable the performance management system 110 to become coupled to other systems, computer systems, remote printers, and/or remote storage devices through intervening private or public networks. Modems, cable modems, transceivers, and Ethernet cards are examples of different types of network adapters 330 that can be used with the performance management system 110.

As pictured in FIG. 3, the memory elements 310 can store the components of the performance management system 110, namely an operating system 335 and a performance management application (or module) 340 configured to perform the processes and method described herein, for example the method 200 described in FIGS. 2a and 2b. Being implemented in the form of executable program code, these components of the performance management system 110 can be executed by the performance management system 110 and, as such, can be considered part of the performance management system 110. Moreover, the operating system 335 and performance management application (or module) 340, as well as the goal management data 112, the goal health status data 114 and the feedback prompt data 116 of FIG. 1, are functional data structures that impart functionality when employed as part of the performance management system 110. In one non-limiting arrangement, the performance management application (or module) 340 can be a component of another application, for example IBM® Kenexa® Talent Suite.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving first information indicating at least a first goal for a first user and storing the first information to a storage device;
monitoring electronic communications communicated in at least one social system and processing, using a processor, the electronic communications to identify at least one of the electronic communications comprising second information related to the first goal;
determining a health of the first goal by processing the second information related to the first goal contained in the identified at least one of the electronic communications; and
responsive to determining the health of the first goal, automatically generating, based on the health of the first goal, a first electronic message prompting a second user to provide to the first user feedback regarding the first goal and communicating the first electronic message for presentation to at least the second user.

2. The method of claim 1, further comprising:
based on the second information related to the first goal contained in the identified at least one of the electronic communications, automatically determining a second goal for the first user; and
responsive to automatically determining the second goal for the first user, automatically generating a second electronic message indicating the second goal and communicating the second electronic message to the first user or the second user.

3. The method of claim 1, wherein determining the health of the first goal comprises:
determining whether the second information related to the first goal contained in the identified at least one of the electronic communications indicates that at least one task or milestone related to the goal has been accomplished.

4. The method of claim 1, wherein determining the health of the first goal comprises:
determining whether the second information related to the first goal contained in the identified at least one of the electronic communications indicates that there has been activity toward achieving the goal.

5. The method of claim 1, further comprising:
presenting to the second user a plurality of proposed feedback messages;
receiving from the second user a selection of at least one of the plurality of proposed feedback messages; and
communicating to at least the first user the selected at least one of the plurality of proposed feedback messages.

6. The method of claim 5, further comprising:
configuring the plurality of proposed feedback messages for a manner in which the selected at least one of the plurality of proposed feedback messages will be communicated to the first user.

7. The method of claim 1, wherein processing the electronic communications to identify the at least one of the electronic communications comprising information related to the first goal comprises:
performing natural language processing on the electronic communications communicated in the at least one social system.

8. A system, comprising:
a processor programmed to initiate executable operations comprising:
receiving first information indicating at least a first goal for a first user and storing the first information to a storage device;
monitoring electronic communications communicated in at least one social system and processing the electronic communications to identify at least one of the electronic communications comprising second information related to the first goal;
determining a health of the first goal by processing the second information related to the first goal contained in the identified at least one of the electronic communications; and
responsive to determining the health of the first goal, automatically generating, based on the health of the first goal, a first electronic message prompting a second user to provide to the first user feedback regarding the first goal and communicating the first electronic message for presentation to at least the second user.

9. The system of claim 8, the executable operations further comprising:
based on the second information related to the first goal contained in the identified at least one of the electronic communications, automatically determining a second goal for the first user; and
responsive to automatically determining the second goal for the first user, automatically generating a second electronic message indicating the second goal and communicating the second electronic message to the first user or the second user.

10. The system of claim 8, wherein determining the health of the first goal comprises:
determining whether the second information related to the first goal contained in the identified at least one of the electronic communications indicates that at least one task or milestone related to the goal has been accomplished.

11. The system of claim 8, wherein determining the health of the first goal comprises:
determining whether the second information related to the first goal contained in the identified at least one of the electronic communications indicates that there has been activity toward achieving the goal.

12. The system of claim 8, the executable operations further comprising:
presenting to the second user a plurality of proposed feedback messages;
receiving from the second user a selection of at least one of the plurality of proposed feedback messages; and
communicating to at least the first user the selected at least one of the plurality of proposed feedback messages.

13. The system of claim 12, the executable operations further comprising:
configuring the plurality of proposed feedback messages for a manner in which the selected at least one of the plurality of proposed feedback messages will be communicated to the first user.

14. The system of claim 8, wherein processing the electronic communications to identify the at least one of the electronic communications comprising information related to the first goal comprises:
performing natural language processing on the electronic communications communicated in the at least one social system.

15. A computer program product comprising a computer readable storage medium having program code stored thereon, the program code executable by a processor to perform a method comprising:
receiving, by the processor, first information indicating at least a first goal for a first user and storing, by the processor, the first information to a storage device;
monitoring, by the processor, electronic communications communicated in at least one social system and processing, by the processor, the electronic communications to identify at least one of the electronic communications comprising second information related to the first goal;
determining, by the processor, a health of the first goal by processing the second information related to the first goal contained in the identified at least one of the electronic communications; and
responsive to determining the health of the first goal, automatically generating, by the processor, based on the health of the first goal, a first electronic message prompting a second user to provide to the first user feedback regarding the first goal and communicating, by the processor, the first electronic message for presentation to at least the second user.

16. The computer program product of claim 15, the method further comprising:
based on the second information related to the first goal contained in the identified at least one of the electronic communications, automatically determining a second goal for the first user; and
responsive to automatically determining the second goal for the first user, automatically generating a second electronic message indicating the second goal and communicating the second electronic message to the first user or the second user.

17. The computer program product of claim 15, wherein determining the health of the first goal comprises:
determining whether the second information related to the first goal contained in the identified at least one of the electronic communications indicates that at least one task or milestone related to the goal has been accomplished.

18. The computer program product of claim 15, wherein determining the health of the first goal comprises:
determining whether the second information related to the first goal contained in the identified at least one of the electronic communications indicates that there has been activity toward achieving the goal.

19. The computer program product of claim 15, the method further comprising:
presenting to the second user a plurality of proposed feedback messages;
receiving from the second user a selection of at least one of the plurality of proposed feedback messages; and
communicating to at least the first user the selected at least one of the plurality of proposed feedback messages.

20. The computer program product of claim 19, the method further comprising, further comprising:
configuring the plurality of proposed feedback messages for a manner in which the selected at least one of the plurality of proposed feedback messages will be communicated to the first user.
